(19) United States
(12) Patent Application Publication
(10) Pub. No.: US 2007/0069434 A1
(43) Pub. Date: Mar. 29, 2007

(54) Vibration damping device

(75) Inventors: Rentaro Kato, Kasugai-shi (JP); Shijie Guo, Komaki-shi (JP); Takehiro Yamada, Inazawa-shi (JP); Yoshinori Yasumoto, Kasugai-shi (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., KOMAKI-SHI (JP)

(21) Appl. No.: 11/527,570

(22) Filed: Sep. 27, 2006

(30) Foreign Application Priority Data
Sep. 29, 2005 (JP) 2005-284896
Mar. 22, 2006 (JP) 2006-079338

(51) Int. Cl. F16M 1/00

(52) U.S. Cl. 267/141.1; 267/140.11; 267/136

(57) ABSTRACT

A vibration damping device including: at least one elastic plate member adapted to be superposed against a surface of a vibrating member to be damped, and having a natural frequency tuned to a frequency band to be damped in the vibrating member; and a positioning member for positioning the elastic plate member with respect to the surface of the vibrating member.

### INCORPORATED BY REFERENCE

The disclosure of Japanese Patent Applications No. 2005-284896 filed on Sep. 29, 2005, and No. 2006-079338 filed on Mar. 22, 2006, each including the specification, drawings and abstract is incorporated herein by reference in its entirety.

### BACKGROUND OF THE INVENTION

1. Field of the Invention

The present invention relates to a vibration damping device of novel construction, for reducing vibration of vibrating members.

2. Description of the Related Art

Conventionally, vibration damping devices are used for reducing vibration of vibrating members such as an automobile body, or fixtures such as household window glass. These vibration damping devices includes, for example, vibration damping structural members such as asphalt sheets or rubber sheets applied to the surface of a vibrating member, and dynamic dampers having a mass member linked with and supported on a vibrating member via a spring member.

In both vibration damping structural members and dynamic dampers, a wide applied surface area or large mass on the part of the mass member is requited in order to attain effective vibration damping action, which created the problem of heavy weight. An additional problem is that the characteristics of rubber elastomers or the like which make up the asphalt of a vibration damping structural member or the mass member of a dynamic damper are easily affected by temperature, making their vibration damping action temperature-dependent, so that it is difficult to consistently attain the desired vibration damping action.

Additionally, in the case of a dynamic damper, vibration damping action on a vibrating member is attained by tuning the natural frequency of a secondary vibration system composed of a mass-spring system, to match the vibration frequency band to be damped in the vibrating member. Since it is very difficult for this vibration damping action to be exhibited outside the relative narrow frequency band to which the secondary vibration system has been tuned, an inherent problem is the difficulty of attaining affective vibration damping action against vibration in multiple and/or wide frequency bands.

More recently, as vibrating members have become more diverse in type and design, and improved vibration damping action has come to be required, vibration damping devices like that taught in U.S. Pat. No. 6,536,566, have been proposed. This vibration damping device has a design wherein an independent mass member is displaceably positioned spaced apart across a gap from a rigid housing affixed to a vibrating member. When vibration is input, the mass member strikes against the housing via an elastic abutting face, utilizing the energy loss produced by sliding friction and impact during striking to attain vibration damping action.

However, the aforementioned vibration damping device cannot be sufficient to afford fully satisfactory characteristics in terms of either the vibration damping effect it attains, or in terms of weight versus vibration damping effect.

U.S. Pat. No. 5,613,400 utilizes vibration damping action produced by striking of an independent mass member, like U.S. Pat. No. 6,536,566. This document teaches a vibration-damping device that uses a rod-shaped mass having an elongated rod shape with a circular cross section. This vibration damping device has a ball screw shaft of hollow round cylindrical shape, the center bore of which accommodates the rod-shaped mass inserted therein. In particular, U.S. Pat. No. 5,613,400 teaches that a plurality of bushings are externally fitted spaced apart from one another in the axial direction of the rod-shaped mass. An adjustment of the mounting positions of the bushings in the axial direction of the rod-shaped mass varies the natural frequency in the radial direction of the rod-shaped mass, so as to be able to achieve vibration damping action in multiple frequency bands.

However, it is difficult to conceive that the natural frequency of a single rod-shaped mass can be varied simply by varying the mounting positions of bushings on the rod-shaped mass, and it is doubtful whether effective vibration damping action can be attained in multiple frequency bands. Additionally, since striking of the rod-shaped mass against the ball screw shaft via the bushings takes place at inside and outside peripheral faces having circular cross sections, the strike face is a simple point or line. As a consequence, the mode of striking of the rod-shaped mass against the ball screw shaft is simple as well; and it must be concluded that ultimately effective vibration damping action is exhibited in only a very narrow vibration frequency band.

### SUMMARY OF THE INVENTION

It is therefore one object of this invention to provide a vibration damping device of novel construction, capable of exhibiting vibration damping action against vibration in multiple and/or wide frequency bands, by means of a simple construction.

The above and/or optional objects of this invention may be attained according to at least one of the following modes of the invention. The following modes and/or elements employed in each mode of the invention may be adopted at any possible optional combinations. It is to be understood that the principle of the invention is not limited to those modes of the invention and combinations of the technical features, but may otherwise be recognized based on the teachings of the present invention disclosed in the entire specification and drawings or that may be recognized by those skilled in the art in the light of the present disclosure in its entirety.

A first mode of the invention provides a vibration damping device comprising: an elastic plate member adapted to be superposed against a surface of a vibrating member to be damped, and having a natural frequency tuned to a frequency band to be damped in the vibrating member; and a positioning member for positioning the elastic plate member with respect to the surface of the vibrating member.

In the vibration damping device constructed in accordance with this mode, the elastic plate member undergoes elastic deformation on the surface of the vibrating member in association with input of vibration of the vibrating member, and bending vibration is produced in the elastic plate member. Vibration damping action (vibration attenuating action) against the vibrating member is exhibited on the basis of this bending vibration. In particular, by means of tuning the natural frequency of the elastic plate member to the frequency band to be dumped, high vibration damping action can be attained efficiently through bending resonance of the elastic plate member.

Additionally, in association with elastic deformation by the elastic plate member, the contact face of the elastic plate member and the vibrating member changes, so that the mode of support of the elastic plate member with respect to the vibration damping device changes, whereby the natural frequency of the elastic plate member changes as well. Consequently, even where vibration to be damped hu several and variable frequencies, the vibration peak will move and resonance action will be exhibited. As a result, the effective range of vibration damping action afforded by tuning can be expanded, and effective vibration damping action can be attained over multiple and/or wide frequency bands.

Further, when a certain magnitude of vibration is input, a part or an entire of the elastic plate member moves away from the vibrating member and strikes against the vibrating member, exhibiting effective vibration damping action based on energy loss through sliding friction or impact. With this arrangement, when large vibration is input and the elastic plate member undergoes jumping deformation, a prescribed effective vibration damping action can be attained even where the elastic plate member is not exactly positioned in accordance with the vibration mode of the vibrating member.

In the vibration damping device of this mode, since vibration damping action is attained efficiently utilizing bending resonate of the elastic plate member, it is possible to achieve effective vibration damping action even with a elastic plate member of relatively small mass. Additionally, since the elastic plate member is of plate shape and is disposed superposed along the surface of the vibrating member, sufficient mass on the part of the elastic plate member can be advantageously assured, while utilizing a small installation space to avoid interference with other members.

In the vibration damping device of this mode, bending deformation produced in the plate-shaped elastic plate member by means of exciting force exerted on the elastic plate member by the vibrating member is produced in multiple directions, as compared to that of a member of circular rod shape. Depending on the mode of vibration of the vibrating member, elastic deformation is produced not only in the longitudinal direction (lengthwise direction) but in the lateral direction (width direction) of the elastic plate member as well. Additionally, the plate-shaped elastic plate member readily comes into linear or planar contact (rather than point contact) with the vibrating member, with the location where the elastic plate member strikes the vibrating member undergoing change depending on the mode of vibration of the vibrating member. Thus, vibration damping action afforded by bending resonance in the elastic plate member as described above, by sliding friction during striking against the vibrating member, by vibration canceling and the like can be exhibited effectively against vibrations of various kinds occurring in the vibrating member. Consequently, it is possible to attain effective vibration damping action against vibration of multiple or different frequency ranges, or vibration of different modes, in the vibrating member.

Additionally, in the vibration damping device of this mode, by furnishing positioning member for the elastic plate member, the elastic plate member is prevented from unwanted movement on the surface of the vibrating member. By so doing, it becomes possible to consistently attain the desired vibration damping action, by means of disposing the elastic plate member at a generally fixed location on the vibrating member.

The positioning member for the elastic plate member may consist of any means for preventing deviation of position of the elastic plate member on the surface of the vibrating member as discussed previously. Additionally, there may be employed, for example, means for restricting the level of relative displacement of the elastic plate member with respect to the vibrating member in the direction of jumping displacement (direction of separation) of the elastic plate member from the vibrating member. The positioning member affixed to the vibrating member is struck by the elastic plate member when the level of displacement of the elastic plate member is restricted in the direction of separation from the vibrating member. With this arrangement, vibration damping action can be attained on the basis of this striking action as well.

A second mode of the invention provides a vibration damping device according to the first mode, wherein a primary natural frequency of the elastic plate member is tuned to the frequency band of vibration to be damped in the vibrating member.

In this mode, vibration damping action can be produced more efficiently, by means of tuning the fundamental vibration of the elastic plate member to the vibration of the resonance frequency of the vibrating member.

A third mode of the invention provides a vibration damping device according to the first or second mode, wherein a natural frequency: f in the elastic plate member is tuned with respect to a frequency: F of the vibration to be damped in the vibrating member, such that 0.8≦f/F≦2.0.

In this mode, extensive testing and research conducted by the inventors has revealed that where the relationship 0.8≦f/F≦2.0 is met, consistent vibration damping action is afforded on the basis of resonance behavior of the elastic plate member. In the vibration damping device of this mode, this is also thought to contributed to an expanded effective range of vibration damping action afforded by tuning, by means of varying the natural frequency of the elastic plate member through change of the contact face of the elastic plate member and the vibrating member in association with elastic deformation by the elastic plate member.

A fourth mode of the invention provides a vibration damping device according to any one of the first through third modes, wherein the elastic plate member and the vibrating member are brought into abutting contact at respective contact faces, and a rubber elastic layer is provided to at least one of the contact faces of the vibrating member and the elastic plate member.

In this mode, the vibrating member and the elastic plate member come into cushion-wise contact via a rubber elastic layer, effectively reducing noise during contact.

A fifth mode of the invention provides a vibration damping device according to any one of the first through fourth modes, wherein the positioning member positions an outside peripheral edge of the elastic plate member with respect to the vibrating member.

In this mode, a large effective surface area of the elastic plate member with respect to the vibrating member is assured, and vibration damping action based on elastic deformation of the elastic plate member can be further improved.

A sixth mode of the invention provides a vibration damping device according to any one of the first through fifth modes, wherein the positioning member includes a positioning hole formed onto the elastic plate member, and positions an inside peripheral edge of the positioning hole with respect to the vibrating member.

In this mode, a lighter elastic plate member and more compact positioning member are achieved; thereby affording further weight reduction of the vibration damping device fished with the positioning member.

As the positioning member for positioning the inside peripheral edge of a positioning hole with respect to the vibrating member, there could be appropriately employed a bolt or pin affixed to the vibrating member, for example. An advantage of employing a bolt or pin, in addition to ease of positioning, is that the positioning member can be made smaller in size. Smaller size of the positioning member is effective in terms of ensuring adequate mass and effective surface area of the elastic plate member. By means of this approach, it becomes possible, for example by locating the bolt or pin in a node section of the elastic plate member, to easily position the elastic plate member at a prescribed location on the vibrating member, while avoiding any adverse effects on elastic deformation and/or resonance behavior of the elastic plate member.

A seventh mode of the invention provides a vibration damping device according to any one of the first through sixth modes, wherein a plurality of elastic plate members are superposed at different locations on the surface of the vibrating member.

In this mode, it is possible for vibration damping action to be advantageously achieved with respect to a vibrating member that gives rise to vibration in multiple modes, including a primary or other low order vibration mode. It is possible to attain further improved vibration damping action, by examining the multiple antinodes of the vibration modes and superposing against each antinode location the elastic plate members tuned to the natural frequency of that mode.

An eighth mode of the invention provides a vibration damping device according to any one of the first through seventh modes, wherein the elastic plate member is formed of metal material or resin material.

In this mode, temperature-induced variability of characteristics is loss than with a rubber elastic body or the like, so that temperature-dependence of vibration damping action may be reduced or avoided, and stable tuning frequency attained.

As will be apparent from the preceding description, in a vibration damping device constructed in accordance with the present invention, the bending resonance of the elastic plate member per so can be utilized to attain vibration damping action through striking. Consequently, even where input vibration energy is low, effective vibration damping action is produced by efficient striking of the elastic plate member against the vibrating member, through bending resonance behavior on the part of the elastic plate member. In particular, bending resonance is effectively produced through the use of an elastic plate member of plate shape, whereby even with a substantially unchanged center of gravity of the elastic plate member, i.e. with substantially no lift-up of the elastic plate member as a whole away from the vibrating member, effective striking against the vibrating member is nevertheless produced on the basis of bending resonance.

Additionally, by utilizing resonance behavior of the elastic plate member, a high level of striking force can be exhibited even where the input vibration energy of the vibrating member is low.

In this way, by focusing upon the resonance behavior of the elastic plate member per se and utilizing the striking action afforded by this resonance behavior, it becomes possible to realize a vibration damping device of novel structure not encountered in the prior art. Thus, effective vibration damping action can be produced against small to largo vibrations, by means of the elastic plate member having sufficiently smaller mass than a dynamic damper, damping steel plate, or similar conventional means.

It has been demonstrated that in the vibration damping device pertaining to the present invention, due to change in the contact face of the elastic plate member and the vibrating member in association with elastic deformation by the elastic plate member, the natural frequency of the elastic plate member per se is not fixed but can vary throughout a certain frequency band. Consequently, even in instances where the vibration to be damped has multiple frequencies or falls within a certain frequency band, by establishing the tuning frequency within a frequency band that includes these multiple frequencies, it is possible to consistently attain vibration damping action against vibration of multiple frequencies and vibration within a certain frequency band as discussed above, through striking based on resonance behavior.

Additionally, when excessively large vibration is input, the elastic plate member undergoes jumping deformation and strikes against the vibrating member. Therefore, an even higher level of vibration damping action is exhibited on the basis of this striking action of the elastic plate member. That is, in addition to the striking occurring in association with bending deformation based on resonance behavior, there is produced added vibration damping action through reverberation and striking of the entire mass of the elastic plate member against the vibrating member.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein;

FIG. 1 is a top plane view of a vibration damping device of construction according to a first embodiment of the invention;

FIG. 2 is a cross sectional view taken along line 2-2 of FIG. 1;

FIG. 3 is a vertical cross sectional view of a schematic model of a damper plate in one operational state, which is employed in the vibration damping device of FIG. 1;

FIG. 4 is a vertical cross sectional view of a schematic model of a damper plate in another operating state, which is employed in the vibration damping device of FIG. 1;

FIG. 5 is a top plane view of a vibration damping device of construction according to a second embodiment of the invention;

FIG. 6 is a cross sectional view taken along line 6-6 of FIG. 5;

FIG. 7 is a top plane view of a vibration damping device of construction according to a third embodiment of the invention;

FIG. 8 is a cross sectional view taken along line 8-8 of FIG. 7;

FIG. 9 is a vertical cross sectional view of a vibration damping device of construction according to a fourth embodiment of the invention, taken along line 9-9 of FIG. 10;

FIG. 10 is a top plane view of the vibration damping device of FIG. 9;

FIG. 11 is a front elevational view schematically showing an examination device with respect to the vibration damping device of the invention;

FIG. 12 is a graph demonstrating a result of measurements relating to vibration damping effect exhibiting by the damper plate disposed on the examination device of FIG. 11, with the damper plate being tuned to a given frequency range;

FIG. 13 is a graph demonstrating a result of measurements relating to vibration damping effect exhibiting by the damper plate disposed on the examination device of FIG. 11, with the damper plate being tuned to another frequency range;

FIG. 14 is a graph demonstrating a result of measurements relating to vibration damping effect exhibiting by the damper plate disposed on the examination device of FIG. 11, with the damper plate being tuned to yet another frequency range;

FIG. 15 is a front elevational view schematically showing an examination device with respect to the vibration damping device of the invention, whose construction is different from that of the examination device of FIG. 11; and

FIG. 16 is a graph demonstrating a result of measurements relating to vibration damping effect of the present vibration damping device by means of the examination device of FIG. 15.

### DETAILED DESCRIPTION OF PREFERRED EMBODIMENTS

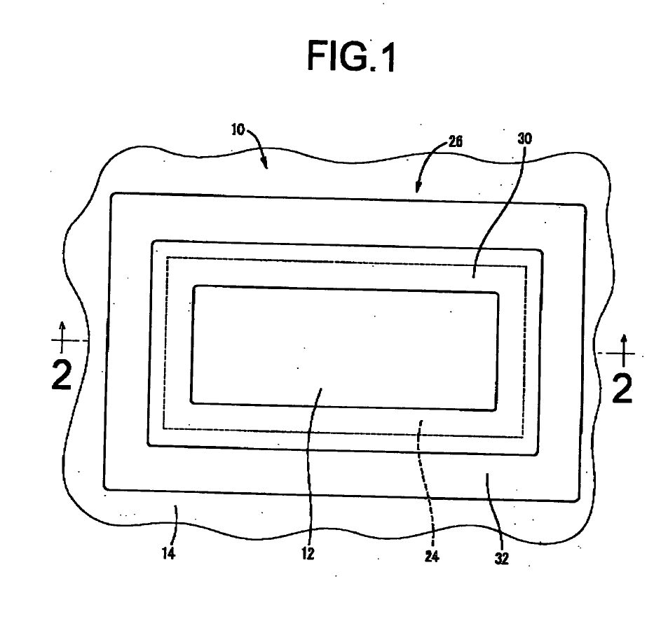

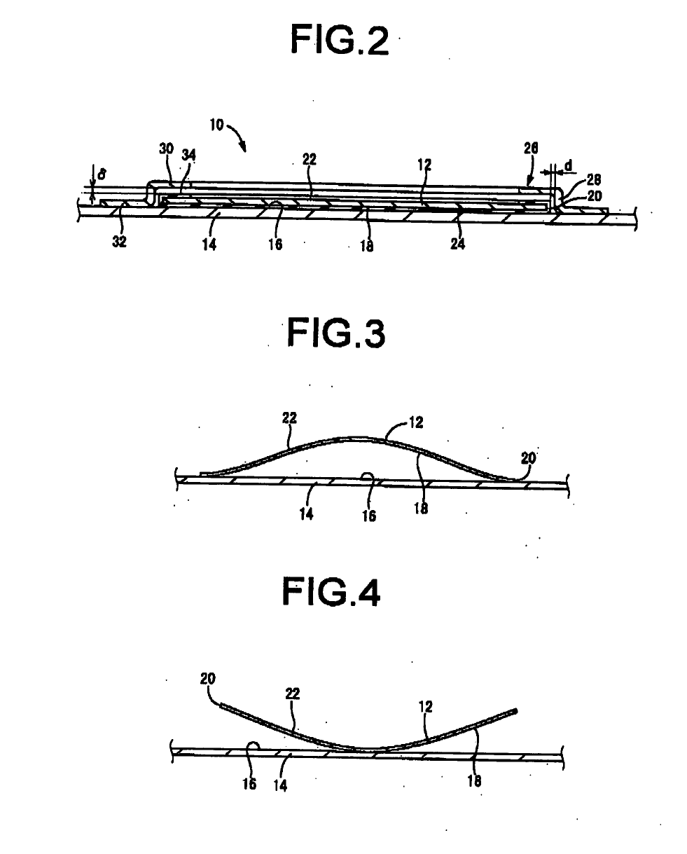

FIGS. 1 and 2 depict a vibration damping device 10 pertaining to a first embodiment of the invention. The vibration damping device 10 includes a damper plate 12 as an elastic plate member. The damper plate 12 is disposed superposed against a surface 16 of a vehicle body 14 as the vibrating member targeted for damping. With this arrangement, the vibration damping device 10 is mounted on the vehicle body 14 constituting the primary vibration system, and serves as a secondary vibration system for the primary vibration system.

More specifically described, the damper plate 12 is made of a metallic material such a iron or aluminum, a resin material such as nylon resin, or a composite material thereof. The size, mass, and shape of the damper plate 12 will be established appropriately depending on the shape and size of the mounting area (surface 16) of the vehicle body 14 which constitutes the vibrating member, and/or on the mounting area mass and vibration frequency band, and similar considerations, while not limited in any particular way. In preferred practice, it will have a rectangular plate shape as depicted in the drawing.

In order to produce bending deformation relatively easily, preferably, the damper plate 12 will be designed with a sufficiently large length dimension relative to its thickness dimension. The ratio of the length dimension: L to the thickness dimension: t is preferably 50≦L/t≦10000, more preferably 100≦L/t≦1000. While the planar shape need not necessarily be rectangular, a rectangular shape is preferred for the purpose of creating consistent bending deformation. In this case, in order to effectively impart damping force to the vibrating member (vehicle body 14), the width dimension: B will be such that 1≦L/B≦10. In order to consistently efficiently produce deformation through bending resonance of the damper plate 12, it will preferably have unchanging thickness dimension throughout its entirety. Additionally, in order for vibration damping action to be produced effectively with respect to the vibrating member, the vibrating member surface 16 and the superposed face of the damper plate 12 will both be flat.

The flexural strength of the damper plate 12 will be considered when deciding upon the thickness dimension of the damper plate 12, depending on the magnitude of input vibration, the rigidity (strength) of the vibrating member, and so on.

The mass of the damper plate 12 is determined in consideration of the vibration energy that is to be damped, and is appropriately about 0.05-10% of the mass of the damping target area, preferably 0.1-5%. However, if the mass is too small, it will be difficult to attain sufficient vibration damping action, whereas if the mass is too large, heaviness tends to become a problem.

An entire first side surface 18 (the lower side in FIG. 2) of the damper plate 12 and an outside peripheral edge portion (face) 20, as well as an area of generally rectangular frame shape along the outside periphery of a second side surface 22 (the upper side in FIG. 2), are covered by a contact rubber layer 24 as the rubber elastic layer. As the material for the contact rubber layer 24, it is possible to employ natural rubber or other diene rubber, chlorine rubber, or various other types of elastomer material. In the present invention, since the principal purpose of the contact rubber layer 24 is to reduce striking noise which can pose a problem when the damper plate 12 strikes the vehicle body 14 constituting the vibrating member, the rubber material and rubber hardness are not limited in any particular way. In cases where the damper plate 12 consists of resin material for example, there are many instances in which no contact rubber layer 24 will be required. From the standpoint of reducing striking noise, an elastomer material with Shore D hardness of 20-40 is appropriately employed as the contact rubber layer 24. In this embodiment, the thickness dimension of the contact rubber layer 24 is substantially unchanging throughout, and is sufficiently small relative to the thickness dimension of the damper plate 12.

The first side surface 18 of the damper plate 12 is superposed against the surface 16 of the vehicle body 14, via the contact rubber layer 24. Here, the vibration mode of the vehicle body 14 to be damped (in this embodiment, primary mode) has been ascertained in advance, and the damper plate 12 has been superposed at a location representing the antinode of that vibration mode. It is not necessary to coincide with the primary mode of the vehicle body 14, and may instead coincide with the location representing the antinode of a vibration mode that is a secondary or higher order mode. The first side surface 18 of the damper plate 12 furnished with the contact rubber layer 24, and the area of the vehicle body 14 against which the damper plate 12 is superposed, i.e. the surface 16 of the location which in the antinode of the vibration mode, are constituted as mutually flat horizontal surfaces. As will be apparent from the preceding description, the contact surfaces of the vehicle body 14 and the damper plate 12 are constituted so as to include the surface 16 of the vehicle body 14 and the first side surface 18 of the damper plate 12.

The thickness dimension of the damper plate 12 is smaller by a prescribed amount than the thickness dimension of the vehicle body 14 in the area against which the damper plate 12 is superposed. In this embodiment, the ratio: T/t of damper plate 12 thickness dimension: t to vehicle body 14 thickness dimension: T is preferably 1≦T/t≦10, more preferably 2≦T/t≦5.

A support fitting 26 servings positioning member is disposed to the outside peripheral side of the damper plate 12 on the vehicle body 14. The support fitting 26 consists of iron, aluminum alloy or other metal material, synthetic resin material, or the like. The support fitting 26 has a generally rectangular frame shape of generally constant width dimension, and has generally constant thickness dimension throughout.

In the medial portion across the width of the support fitting 26, there is formed a vertical wall portion 28 rising in the thickness direction (the vertical in FIG. 2) to produce a stepped shape. On the support fitting 26, an inward plate portion 30 of rectangular frame shape is formed extending toward the inner peripheral side from the edge of one side of the vertical wall portion 28 (the upper side in FIG. 2), while an outward plate portion 32 of rectangular frame shape larger than the inward plate portion 30 is formed extending toward the outer peripheral side from the edge of the other side of the vertical wall portion 28 (the lower side in FIG. 2). That is, the support fitting 26 has the form of a rectangular inverted dish whose medial section projects slightly upward, with a rectangular window portion formed in the projecting medial portion, giving it a rectangular frame shape overall.

The vertical wall portion 28 of the support fitting 26 is positioned so as to enclose the damper plate 12 completely from the outside peripheral side. The outward plate portion 32 of the support fitting 26 is superposed against the surface 16 of the vehicle body 14 and secured by welding, bolting or other means. By so doing, the outside peripheral edge portion 20 of the damper plate 12 is positioned with respect to the vehicle body 14 by means of the support fitting 26, and the damper plate 12 is disposed in a stable manner on the surface 16 of the vehicle body 14 to be damped.

Between the vertical wall portion 28 and inward plate portion 30 of the support fitting 26, and the outside peripheral edge of the damper plate 12 furnished with the contact rubber layer 24, there is formed a gap 34 extending throughout. Specifically, the length dimension and width dimension of the damper plate 12 furnished with the contact rubber layer 24 are smaller than the length dimension and width dimension of the vertical wall portion 28. By means of this design, the vertical wall portion 28 and the contact rubber layer 24 covering the outside peripheral edge portion 20 of the damper plate 12 are positioned spaced apart by a separation distance: d. The thickness dimension of the damper plate 12 furnished with the contact rubber layer 24 is smaller than the height dimension of the vertical wall portion 28. By meant of this design with the damper plate 12 superposed against the vehicle body 14, the inward plate portion 30 of the support fitting 26 and the contact rubber layer 24 covering the outside peripheral edge of the second side surface 22 of the damper plate 12 are positioned in opposition to one another, spaced apart by a separation distance: δ.

In this embodiment, in order to achieve effective vibration damping action of vibration in the principal vibration input direction of the vehicle body 14 (the vertical direction in FIG. 2), the support fitting 26 is formed with a sufficiently large gap with respect to the damper plate 12 furnished with the contact rubber layer 24. That is, it is desirable that the support fitting 26 not interfere with the damper plate 12 furnished with the contact rubber layer 24, during damping or elastic deformation and resonance of the damper plate 12. However, it is also desirable that the damper plate 12 be positioned stably with respect to a prescribed location on the vehicle body 14, specifically, the area representing the antinode of the vibration mode being damped, described later. Consequently, the support fitting 26 is designed to a size enabling it to function so as to keep moving displacement of the damper plate 12 to within a prescribed range, while avoiding interference with the damper plate 12 to the utmost degree possible.

Specifically, the displacement of the damper plate 12 is held within a range of 0.1 mm≦δ≦1.0 mm, and within a range of 0.1 mm≦d≦5.0 mm, for example. With the damper plate 12 spaced apart from the vehicle body 14 and situated in the height-wise middle of the vertical wall portion 28, a separation distance: δ/2 is maintained to either side of the damper plate 12 in the thickness direction (vertical direction in FIG. 2). Also, the damper plate 12 is prevented from moving more than a distance: 2d in either the lengthwise direction or the width direction on the surface of the vibrating member.

Setting the gap: δ in the thickness direction of the damper plate 12 (vertical direction in FIG. 2) with respect to the support fitting 26 to a relatively small distance can also be utilized as a tuning method. Specifically, in consideration of bending deformation or jumping deformation of the damper plate 12, the support fitting 26 is formed with a small gap: δ such that the outside peripheral edge portion of the damper plate 12 comes into contact with it. By so doing, the damper plate 12 can be induced through bending deformation or jumping displacement thereof to actively strike against not only the surface 16 of the vehicle body 14 per so constituting the vibrating member, but also against the support fitting 26 affixed to the vehicle body 14. That is, during deformation or displacement of the damper plate 12, by having it strike at both ends of the stroke thereof, it is possible for the vibration damping action produced by striking to act more efficiently on the vibrating member.

In the vibration damping device 10 described above, the damper plate 12 of relatively high elastic modulus is disposed superposed against the surface 16 of the vehicle body 14, whereby considerable elastic deformation is permitted on the surface 16. Specifically, as depicted in elastic deformation model in FIGS. 3 and 4, the damper plate 12 undergoes elastic deformation on the surface 16 of the vehicle body 14 in association with vibration of the vehicle body 14 which represents the primary vibration system. In FIGS. 3 and 4, the extent of deformation is shown greatly exaggerated, in order to describe the mode of deformation.

In this deformation, with the first side surface 18 of the damper plate 12 initially in a state of contact with the surface 16 of the vehicle body 14, the center section of the damper plate 12 now gradually moves away from the vehicle body 14, assuming a peak cross section overall in which only the peripheral portions of the damper plate 12 remain in contact with the vehicle body 14 (see FIG. 3); or with the first side surface 18 of the damper plate 12 initially in a state of contact with the surface 16 of the vehicle body 14, the peripheral portions of the dapper plate 12 gradually move away from the vehicle body 14, assuming a valley cross section overall in which only the center portion of the damper plate 12 remains in contact with the vehicle body 14 (see FIG. 4). Specifically, bending vibration is produced in the damper plate 12 in association with vibration of the vehicle body 14. On the basis of this bending vibration, there is produced a vibration attenuating action against the vehicle body 14 representing the primary vibration system.

In this embodiment in particular, the primary natural frequency: f of the damper plate 12 is tuned to 0.8-2.0 times, preferably 1.0-1.6 times the primary mode vibration frequency: F of the vehicle body 14 being damped. In other words, the relationship of the primary natural frequency: f of the damper plate 12 and the primary mode vibration frequency: F of the vehicle body 14 to be damped is 0.8≦f/F≦2.0, preferably 1.0≦f/F≦1.6. The vibration frequency: F to be damped is deemed the primary mode vibration frequency of the vehicle body 14. The primary natural frequency; f of the damper plate 12 is measured with the damper plate 12 placed in a freely supported state.

By means of increasing or decreasing size of the contact surface of the damper plate 12 and the vehicle body 14 in association with elastic deformation of the damper plate 12, the form of contact of the damper plate 12 against the vehicle body 14 varies continuously. Consequently, the natural frequency of the damper plate 12 varies as well, and resonance behavior is exhibited over a wide frequency band. Experimentation conducted by the inventors has shown that extremely effective vibration damping action is attained where a setting of 1.0≦f/F≦1.6 is employed.

Consequently, in addition to efficiently attaining large vibration damping action based on bending resonance of the damper plate 12, vibration damping action can be exhibited effectively over multiple, wide frequency bands by utilizing the change in natural frequency of the damper plate 12 produced by change in the contact surface of the damper plate 12 and the vehicle body 14.

During vibration input, the damper plate 12 undergoes relative displacement with respect to the vehicle body 14 in the gap between the vehicle body 14 and the inward plate portion 30 of the support fitting 26, and strikes the vehicle body 14. Accordingly, vibration damping action is produced through sliding friction action and impact action. Vibration damping action based on the damper plate 12 striking against the vehicle body 14 in this way is not based on unequivocal resonance behavior, and thus effective vibration damping action can be attained over a wide frequency band, and consistent vibration damping action with less temperature-induced variation in characteristics can be attained.

A more detailed examination conducted by the inventors has revealed that by setting the natural frequency of the primary bending mode of the width direction of the damper plate 12 (the vertical direction in FIG. 1) to the natural frequency of the vehicle body 14, that is, by setting the mode of the length direction of the damper plate 12 (the sideways direction in FIG. 1) and the mode of the width direction to mutually different characteristic frequencies, vibration damping action of multiple vibration modes by a single damper plate 12 is effectively attained. Similar effects are obtained by means of resonance of the damper plate 12, in other modes such as the twisting direction, etc.

From this as well, it has been demonstrated that by employing in particular a damper plate 12 of rectangular flat plate shape in the vibration damping device 10 of the embodiment, the mode of the width direction can be utilized in addition to the mode of the length direction, effectively producing energy loss through bending resonance, sliding friction, or impact. Thus, the desired vibration damping action is consistently attained, even where the natural frequency of the vehicle body 14 varies, for example.

Additionally, in this embodiment, the mass of the damper plate 12 is 0.1-5% of the mass of the area targeted for damping of the vehicle body 14. This means that the mass is much smaller than would be the mass of a dynamic damper or damping structural member of conventional design attached to the same area targeted for damping. However, since the desired vibration damping action is adequately attained based on bending resonance mainly through elastic deformation of the damper plate 12, there is no need for any special consideration of vibration damping action based on the mass of the damper plate 12, such as striking action of the damper plate 12 against the vehicle body 14, for example. Consequently, the vibration damping device 10 can be advantageously reduced in weight, which is of course favorable for use with vibrating members having strict limitations as to mass.

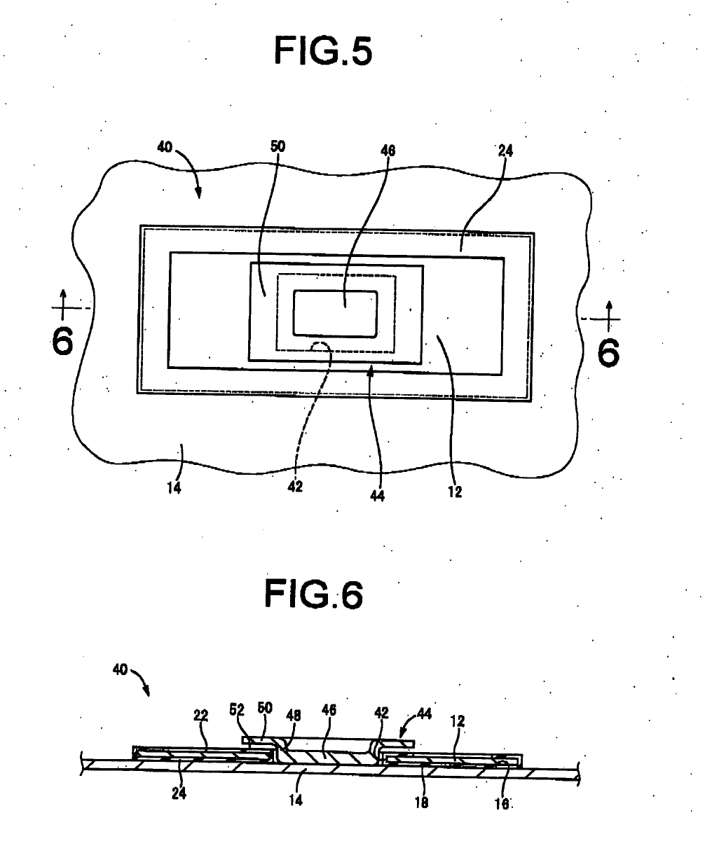

Next, a vibration damping device 40 pertaining to a second embodiment of the invention is depicted in FIGS. 5-6. In the following description, components and parts substantially identical in structure to those of the first embodiment have been assigned the same symbols as in the first embodiment in the drawings, and will not be described in detail.

In greater detail, the center portion of the damper plate 12 is perforated by a generally rectangular positioning hole 42. In other words, the damper plate 12 of this embodiment is of generally rectangular frame shape. The inside peripheral edge of the damper plate 12 constituting the positioning hole 42 is integrally covered by the contact rubber layer 24 covering the first side surface 18 of the damper plate 12, with the contact rubber layer 24 extending around to the inside peripheral side of the second side surface 22 of the damper plate 12 as well, so as to cover an area of generally rectangular frame shape on the inside, peripheral side of the second side surface 22. A support fitting 44 is disposed as positioning member on the vehicle body 14 to the inside to this positioning hole 42.

The support fitting 44 has rectangular flat plate shape of generally constant thickness, and is formed using rigid material such as a metallic material or a synthetic resin material. Through a pressing process or the like the central portion of the support fitting 44 is made to project out in a rectangular shape to one side in the thickness direction (downward in FIG. 6). A rectangular cup-shaped inward plate portion 46 is integrally formed in the center of the support fitting 44, and a rectangular frame shaped outward plate portion 50 spreading out towards the outside peripheral side is integrally formed on a peripheral wall portion 48 extending to one side in the axial direction (upward in FIG. 6) from the outside peripheral edge of the inward plate portion 46. The inward plate portion 46 and the outward plate portion 50 are spaced apart by a distance equivalent to the height dimension of the peripheral wall portion 48. The inward plate portion 46 of this support fitting 44 is superposed against the surface 16 of the vehicle body 14 exposed within the positioning hole 42 of the damper plate 12, and affixed thereto by welding, bolts or the like. With this arrangement, the inside peripheral edge of the positioning hole 42 of the damper plate 12 is positioned with respect to the vehicle body 14 by means of the support fitting 44, so that the damper plate 12 is stably positioned on the surface 16 of the vehicle body 14 targeted for damping.

Between the peripheral wall portion 48 and the outward plate portion 50 of the support fitting 44 on the one hand, and the inside peripheral portion of the damper plate 12 furnished with the contact rubber layer 24 on the other, there is formed a gap 52 extending throughout. Specifically, the longitudinal dimension and lateral dimension of the positioning hole 42 of the damper plate 12 furnished with the contact rubber layer 24 are larger than the longitudinal dimension and lateral dimension of the peripheral wall portion 48. With this design, the peripheral wall portion 48 and the contact rubber layer 24 covering the inside peripheral edge of the damper plate 12 are spaced apart by a prescribed separating distance in the horizontal direction (vertical and sideways in FIG. 5). With the damper plate 12 superposed against the vehicle body 14, the outward plate portion 50 of the support fitting 44 and the contact rubber layer 24 covering the inside peripheral side of the other second side surface 22 of the damper plate 12 are positioned in opposition spaced apart by a prescribed separating distance in the vertical direction (vertical in FIG. 6).

In the vibration damping device 40 of the above construction as well, the damper plate 12 is designed to permit bending deformation and jumping displacement, with substantially no interference with respect to the support fitting 26. During bending deformation or jumping displacement, the damper plate 12 strikes against the surface 16 of the vehicle body 14. As a result, there is afforded effective vibration damping action analogous to that of the first embodiment.

In this embodiment, free displacement of the damper plate 12 is restricted, and the support fitting 26 for stabilizing the placement location thereof, i.e. the striking location, is disposed in the central portion of the damper plate 12. With this arrangement, where outside peripheral installation space is limited, it is possible to advantageously increase the mass of the damper plate 12 in the outside peripheral edge portion of a space efficiently ensuring sufficient mass on the part of the mass member.

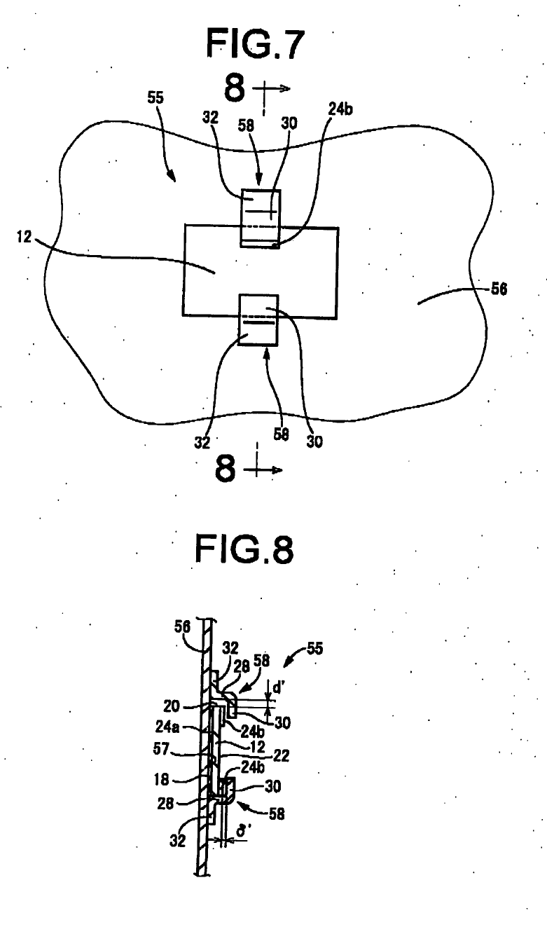

Next, a vibration damping device 55 pertaining to a third embodiment of the invention is depicted in FIGS. 7-8. The damper plate 12 of this vibration damping device 55 is disposed superposed against a surface 57 of a window glass 56 as the vibrating member in a residence, office building, vehicle or the like.

In greater detail, the first side surface 18 of the damper plate 12 is superposed against the flat surface 57 on one side of a pane of window glass 56 extending in the vertical direction (vertical in FIG. 7, 8). The damper plate 12 is covered by a contact rubber layer 24a formed covering the entire first side surface 18 on the side superposed against the window glass 56. This contact rubber layer 24a is of constant thickness throughout.

A vertical pair of support members 58 are secured superposed against the surface 57 of the window glass 56. The support members 58 are of narrow-width plate shape having the same cross sectional shape as the support fitting 26 of the first embodiment. The pair of support members 58 are positioned spaced apart from each other in the vertical direction, facing one, another so as to hold up their heads to one another.

The damper plate 12 positioned superposed against the surface 57 of the window glass 56 is supported at top and bottom by the pair of support members 58. Specifically, in this embodiment, the pair of support members 58 constitute the positioning member for limiting the level of displacement of the damper plate 12.

The damper plate 12 is also covered by a thin contact rubber layer 24b, in the portions thereof against which the support members 58 are superposed.

The dimension of the damper plate 12 in the vertical direction (vertical in FIGS. 7, 8) is smaller by a prescribed distance: d′ than the distance between the opposing faces of the vertical wall portions 28, 28 of the pair of support members 58, 58. The thickness dimension of the damper plate 12 (including the contact rubber layers 24a, 24b) is smaller by a prescribed distance: δ′ than the height dimension of the vertical wall portions 28 of the support members 58. By means of this design, the damper plate 12 installed on the surface 57 of the window glass 56 is allowed to undergo elastic deformation and displacement in the direction away from the window glass 56, while the extent of displacement thereof in the vertical and lateral directions in FIG. 8 is restricted, by the pair of support members 58, 58.

In this embodiment in particular, since the damper plate 12 has a so-called vertical installation structure in which it is disposed superposed against the surface 57 of window glass 56 extending in the vertical direction (vertical in FIGS. 7, 8) the lower outside peripheral edge portion 20 of the damper plate 12 in FIGS. 7 and 8 rests contacting the vertical wall portion 28 of the lower support member 58 due to gravity. However, if the window glass 56 should vibrate, exerting exciting force on the damper plate 12, the damper plate 12 will vibrate up and away from the support member 58.

The window glass 56 may be inclined to some extent so that the surface 57 thereof against which the damper plate 12 is superposed faces upward. By inclining the window glass 56 upward in this way, the entire perimeter of the damper plate 12 can be disposed apart from the support members 58, through frictional force of the contact rubber layer 24a and the surface 57 of the window glass 56.

In the vibration damping device 55 constructed as described above as well, the damper plate 12 undergoes bending deformation and jumping displacement away from the window glass 56 in association with vibration of the window glass 56. Also, through bending deformation and jumping displacement of the damper plate 12, the damper plate 12 strikes against the surface 57 of the window glass 56. As a result, in a manner analogous to the first and second embodiments, effective vibration damping action is attained on the basis of bending resonance behavior of the damper plate 12, as well as striking action of the damper plate 12 against the window glass 56 and the support members 58, 58.

In this embodiment, in preferred practice the locations of support by the support members 58, 58 will coincide with the locations of the nodes of minimum amplitude in the vibration mode of the damper plate 12 under a condition of input of the principal vibration to be damped in the window glass 56 for example. As a result, unwanted constraint of bending deformation of the damper plate 12 by the support members 58 can be reduced, affording further improvement in bending resonance and striking action.

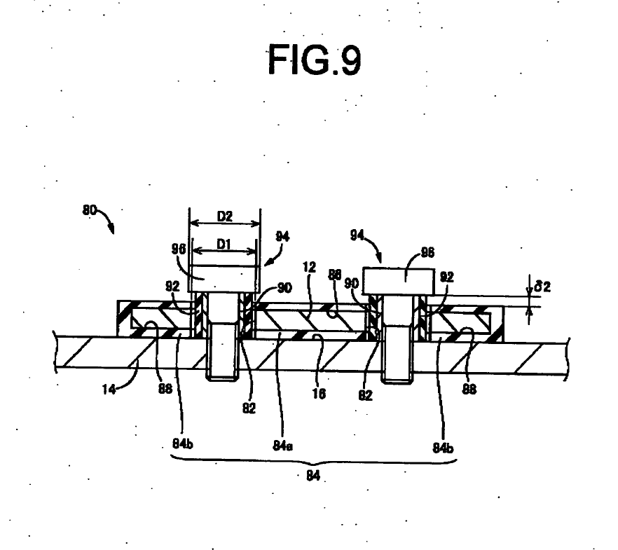

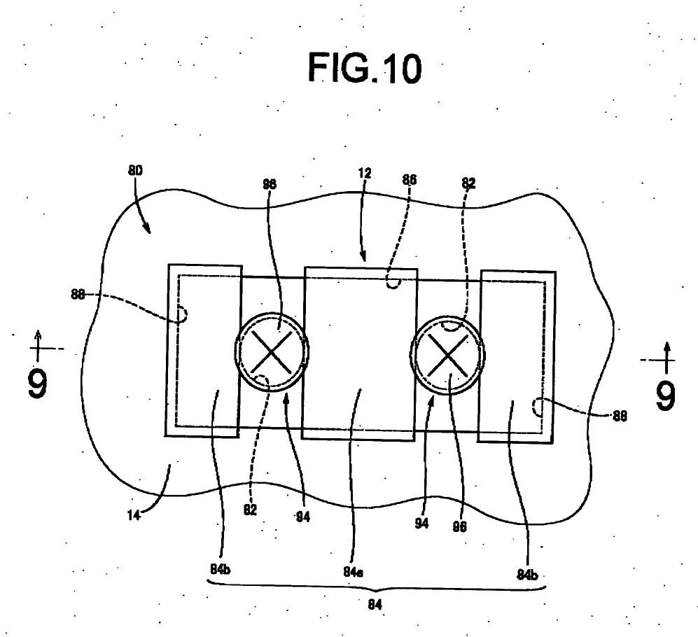

Next, a vibration damping device 80 according to a fourth embodiment of the invention is depicted in FIGS. 9-10. The vibration damping device 80 comprises a damper plate 12 of the same construction as the damper plate pertaining to the first embodiment, but with different dimensions.

In greater detail, the damper plate 12 pertaining to this embodiment is perforated by positioning holes 82. The size, shape, number, location and so on of the positioning hole 82 are not limited in any particular way. In this embodiment, two holes of circular shape are disposed spaced apart in the lengthwise direction (sideways in FIG. 9, 10) in the center of the damper plate 12. Since the damper plate 12 is formed in a metallic material, metal lies exposed at the peripheral wall of each positioning hole 82. In particular, these positioning holes 82, 82 are situated in sections representing nodes of the damper plate 12.

A rubber cap 84 is disposed on the damper plate 12 as the rubber elastic layer. The rubber cap 84 is designed to include a center rubber cap 84a and a pair of end rubber caps 84b.

The center rubber cap 84a has a thick rectangular flat plate shape, and in the center portion of the thickness direction thereof has formed a mating slot 86 of rectangular recessed cross section opening at one end in the lengthwise direction (vertical in FIG. 10) and extending continuously in the width direction (sideways in FIG. 10) to open at both ends in the direction. The center rubber cap 84a is attached to the damper plate 12 by fitting the center portion of the damper plate 12 situated between the pair of positioning holes 82, 82 into this mating slot 86 from one side in the width direction of the damper plate 12 (vertical in FIG. 10). By means of this design, the center portion of the damper plate 12 is sandwiched by the center rubber cap 84a with the two faces of its center portion being covered by the center rubber cap 84a. The center rubber cap 84a is disposed at a location avoiding the positioning holes 82 of the damper plate 12, while the ends of, the center rubber cap 84a in the width direction are positioned above the open end of each positioning hole 82.

The end rubber cap 84b has thick rectangular flat plate shape, and in the center portion of the thickness direction thereof has formed a mating hole 88 of rectangular recessed cross section opening at one end in the lengthwise direction (vertical in FIG. 10). The end rubber cape 84b are attached to the damper plate 12 by fitting the portions of the damper plate 12 situated an the ends thereof with respect to the positioning holes 82 into this mating hole 88 from one side in the lengthwise direction (vertical in FIG. 10) of the damper plate 12. By means of this design, the two lengthwise end portions of the damper plate 12 are sandwiched by the end rubber caps 84b, with the two faces of its ends being covered by the end rubber caps 84b. The end rubber caps 84b are disposed at locations avoiding the positioning holes 82 of the damper plate 12, while the lengthwise end of each center rubber cap 84a in is positioned above the open end of a positioning hole 82.

Like the contact rubber layer 24 pertaining to the first embodiment, the rubber cap 84 which includes the center rubber cap 84a and end rubber caps 84b is employed for the principal purpose of reducing string noise which can pose a problem when the damper plate 12 strikes the vehicle body 14, so the rubber material and rubber hardness are not limited in any particular way. In this embodiment, since the damper plate 12 is formed from a metallic material, from the standpoint of reducing striking noise, an elastomer material with Shore D hardness of 20-40 is appropriately employed as the rubber cap 84.

The damper plate 12 furnished with the rubber cap 84 of this kind is superposed against the surface 16 of the vehicle body 14. In particular, since the surface of the rubber cap 84 is of a shape conforming to the surface 16 of the vehicle body 14 (in this embodiment, a flat shape), the rubber cap 84 is superposed against the vehicle body 14 with no sizeable gap therebetween. In this embodiment, the damper plate 12 is spaced apart from the vehicle body 14 by a distance equivalent to the thickness of the rubber cap 84 covering one surface, but may come into contact with the vehicle body 14 by means of bending, for example.

A collar member 90 is disposed to the inside of the positioning hole 82. The collar member 90 has a small-diameter, round tubular shape, and is formed using metal material. A rubber layer 92 of generally constant thickness dimension throughout is affixed by means of vulcanization bonding or the like to the outside peripheral face of the collar member 90. Specifically, the rubber layer 92 is of round tubular shape slightly larger than the collar member 90. The outside diameter dimension of this rubber layer 92 is smaller than the diameter dimension: D1 of the positioning hole 82. The height dimension of the collar member 90 and the rubber layer 92 is greater than the axial dimension of the positioning hole 82, and greater by a prescribed distance: δ2 than the thickness dimension of the damper plate 12 furnished with the rubber cap 84. The collar member 90 is positioned accommodated in an unbonded state within the positioning hole 82, and placed on the vehicle body 14. The collar member 90 is also furnished with a positioning bolt 94.

The positioning bolt 94 has an integral structure composed of an elongated cylindrical portion with a screw thread on its outside peripheral face, and at one end thereof a head portion 96 having a round plate shape larger in diameter than the cylindrical portion. The diameter dimension of the cylindrical portion of the positioning bolt 94 furnished with a screw thread is smaller than the inside diameter dimension of the collar member 90. The diameter dimension: D2 of the head portion 96 is greater than the outside diameter dimension of the rubber layer 92, and also greater than the diameter dimension: D1 of the positioning hole 82.

The positioning bolt 94 is inserted through the collar member 90, and the thread at its distal end is threaded into the vehicle body 14. The outside peripheral portion of the head portion 96 of the positioning bolt 94 is positioned in opposition to the opening of the positioning hole 82 in the damper plate 12 and the rubber cap 84 covering the area around the opening, in the direction of superposition of the damper plate 12 and the vehicle body 14. In particular, during screw fastening, the head portion 96 of the positioning bolt 94 comes into abutment against the upper end of the collar member 90 placed on the vehicle body 14, thereby regulating the distance separating the head portion 96 and the vehicle body 14. With the rubber cap 84 attached to the damper plate 12 superposed against the vehicle body 14, a prescribed separation distance: δ2 is established between the head portion 96 and the rubber cap 84.

By means of this design, the vibration damping device 80 is disposed on the surface 16 of the vehicle body 14, with the damper plate 12 permitted to undergo bending deformation and jumping displacement with substantially no interference thereof with the multiple (two in this embodiment) positioning bolts 94. The damper plate 12 undergoes bending deformation and jumping displacement in association with input of vibration to the vehicle body 14, whereupon the damper plate 12 strikes against the vehicle body 14 via the rubber cap 84. As a result, effective vibration damping action analogous to the first embodiment is attained.

During bending deformation and jumping displacement, of the damper plate 12, the rubber cap 84 covering the area around the positioning holes 82 comes into abutment against the head portions 96 of the positioning bolts 94, thereby preventing the damper plate 12 from shifting out of place with respect to the vehicle body 14, and holding it in position. Consistent vibration damping action is obtained as a result. An will be apparent from the preceding description, the positioning member of this embodiment is constituted to include the positioning holes 82 and the positioning bolts 94.

In this embodiment in particular, since the damper plate 12 is positioned with respect to the vehicle body 14 by means of positioning bolts 94 as described by way of example, there is no need to employ as the positioning member a special housing of a shape conforming to the surface 16 of the vehicle body 14 for example, and the positioning mechanism can be realized through a simple arrangement. Accordingly, the positioning mechanism is not limited to a vehicle body 14 and damper plate 12 having flat surfaces as described in this embodiment and may be implemented easily for those having curved shapes, for example.

In this embodiment, positioning member comprising the positioning holes 82 and the positioning bolts 94 are situated at two locations apart from each other in the center of the damper plate 12, thereby limiting excessive rotation of the damper plate 12 about the center axis. This arrangement affords more reliable positioning of the damper plate 12 with respect to the vehicle body 14.

Additionally, in this embodiment, by disposing the rubber layer 92 covering the outside peripheral face of the collar member, 90, contact between the collar member 90 and the peripheral wall of the positioning hole 82 when the damper plate 12 undergoes displacement in the planar direction will take place via the rubber layer 92. Consequently, a noise reducing effect during contact is effectively attained.

Since rubber elastic layer pertaining to this embodiment is a mating type rubber cap 84 formed as a separate element from the damper plate 12, it is simple to manufacture. Additionally, depending on the required striking noise reducing effect or mode of placement on the vehicle body 14, or on the elastic deformation or mass of the damper plate 12, the rubber cap 84 may be replaced with a rubber cap of different shape or size than the rubber cap 84, or the rubber cap 84 removed altogether.

While the present invention has been described in detail in its presently preferred embodiment, for illustrative purpose only, it is to be understood that the invention is by no means limited to the details of the illustrated embodiment, but may be otherwise embodied. It is also to be understood that the present invention may be embodied with various changes, modifications and improvements which may occur to those skilled in the art, without departing from the spirit and scope of the invention.

For example, this shape, size, construction or number of the damper plate 12, support fittings, 26, 44 or support member 58, or the mode of placement thereof against the vehicle body 14 or window glass 56 are not limited to those taught herein by way of example.

Specifically, in the preceding embodiments a single damper plate 12 was disposed at a location representing an antinode of the primary vibration mode in the vehicle body 14. It would be possible to instead dispose multiple damper plates at a single vibration mode antinode, or at locations of the antinodes of several vibration modes including primary or other low order vibration modes, disposing a single or two or more damper plates at each, thereby disposing multiple damper plates at different locations on the surface of the body.

It is not necessary for the damper plate 12 to be installed at a location representing an antinode of the vibration mode of the vibrating member, and may be disposed at a location offset from the antinode.

It is acceptable for the contact rubber layer 24 to be disposed only at locations where the damper plate 12 strikes the vehicle body 14. As mentioned previously, the contact rubber layer 24 is not an essential element of the invention. For example, the contact rubber layer 24 could be formed covering the entire face on only onside side of the damper plate 12, or formed covering the entire outside surface.

Further, in the preceding embodiments, the surface 16 of the vehicle body 14 and the first side surface 18 of the damper plate 12, which together constitute the superposed faces of the vehicle body 14 and the damper plate 12, are constituted as mutually flat horizontal faces. However, provided that the damper plate 12 in resonance mode strikes the body 14 at several locations, the effects of the invention will be exhibited effectively. Consequently, for a vibrating member having an irregular surface for example, it would be possible to employ superposed thereagainst an elastic plate member designed to have a strike face that is flat over its entirety. Alternatively, for a vibrating member having a bowing surface, inclined surface, or other irregular shape, it would be possible to employ superposed thereagainst an elastic plate member designed to have a corresponding irregular shape on its surface. Also, by juxtaposing an elastic plate member of flat shape along a flat inclined face of a vibrating member inclined at a prescribed angle with respect to the horizontal, the elastic plate member may be disposed at an incline.

In the fourth embodiment, metal positioning bolts 94 were used as the positioning member, but where for example the positioning member are composed of pins or rivets of a rubber elastic material or synthetic resin material, or where striking noise of the positioning bolts 94 and the damper plate 12 not is a problem, it would not always be necessary to provide a rubber cap 84. For similar reasons, the collar member 90 and the rubber layer 92 are not essential components.

### EXAMPLES

Following is a description of examples of the invention for the purpose of demonstrating the vibration damping action of the vibration damping device pertaining to the invention. However, the invention should not be construed as limited to these examples. In particular, in the working examples, the positioning member has been omitted from the constitutional elements of the embodiment, for the purpose of aiding understanding of the vibration damping action produced by bending resonance of the damper plate and striking thereof against the vibrating member.

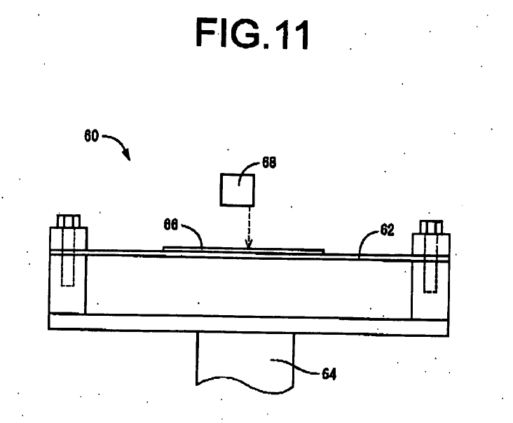

First, the testing apparatus 60 depicted in FIG. 11 was set up. The testing apparatus 60 comprises a base 62 as the vibrating member. The base 62 is of a rectangular flat plate shape, and was fabricated of rigid material such as iron. The two end portions of the base 62 were secured to a vibration exciter 64. The base 62 was subjected to sweep excitation and sine wave excitation by the vibration exciter 64, or to impact excitation by an impulse hammer at a prescribed location on the base 62. The primary vibration mode of the base 62 was examined by mode analysis such as FEM, as well as measuring the primary natural frequency: F of the base 62.

A damper plate 66 serving as the elastic plate member was superposed against the base 62 at a location representing an antinode of the primary vibration mode. The damper plate 66 has a rectangular flat plate shape and was fabricated of resilient metal material. For the test, a damper plate 66a having a primary natural frequency: fa higher by a prescribed level than the primary natural frequency; F, a damper plate 66b′ having a primary natural frequency: fb approximately equal to the primary natural frequency: F, and a damper plate 66c having a primary natural frequency: fc lower by a prescribed level than the primary natural frequency: F were prepared.

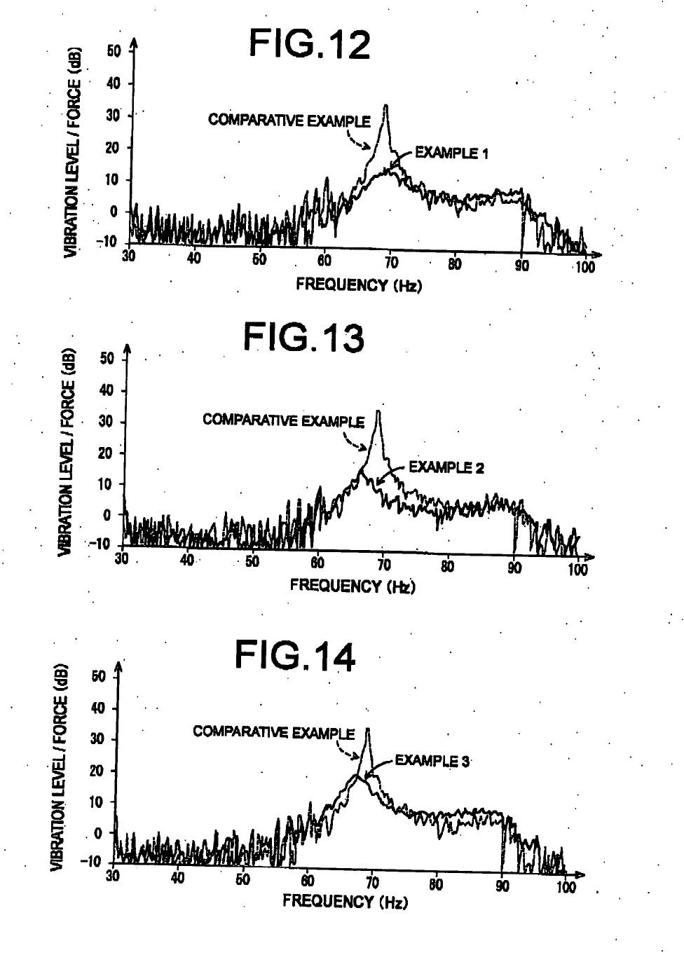

With the damper plates 66a, 66b, 66c individually superposed against an antinode of the base 62, excitation force was applied to the base 62 with the vibration exciter 64 or the impulse hammer, and the resultant vibration level (dB) was measured with a laser vibration gauge 68 of known type. As a result, the results of measuring vibration level of each base 62 having the damper plate 66a, 66b or 66c disposed thereon are indicated as Examples 1, 2 and 3 in FIGS. 12, 13, and 14 respectively. Also shown in FIGS. 12, 13, and 14 as Comparative Examples are results for the base 62 in the absence of the damper plate 66a, 66b or 66c.

From the results in FIGS. 12, 13, and 14 it will be apparent that vibration damping action is effectively exhibited where the vibration damping device is furnished with a damper plate 66b having a tuning frequency: fb approximately equal to the natural frequency: F of the base 62, and also where the vibration damping device is furnished with a damper plate 66a, 66a having a tuning frequency diverging by a prescribed level from the natural frequency: F of the base 62.

In the testing apparatus 60 shown in FIG. 11, a number of damper platen 66 each having a different tuning frequency were prepared, and vibration damping action (dB) of bases 62 furnished, with the damper plates 66 each having a different value for the ratio: f/F of its natural frequency: f to the natural frequency: F of the base 62 within the range 0.8≦f/F≦2.3 was measured. Results are shown in Table 1. In Table 1, results of multiple measurements of vibration damping action under conditions of each ratio: f/F are given.

TABLE 1

| RATIOS: f/F | |
|---|---|
| (f: NATURAL FREQUENCY | |
| OF DAMPER PLATE) | DAMPING |
| (F: NATURAL FREQUENCY | EFFECT |
| OF BASE) | [dB] |
| 0.8 | 14, 14, 15 |
| 0.9 | 13, 17 |
| 1.0 | 17, 18, 19 |
| 1.2 | 20, 23 |
| 1.3 | 19, 21 |
| 1.4 | 19, 19, 21 |
| 1.6 | 16, 17, 20 |
| 1.9 | 11, 15 |
| 2.3 | 7, 10, 11 |

It will be apparent from Table 1 that each of the vibration damping devices fulfilling the relationship 0.8≦f/F≦2.3 afforded vibration damping action, and that vibration damping around 20 dB, required for damping of the base 62, was attained particularly effectively with a vibration damping device in the range 1.0≦f/F≦1.6.

Consequently, in the vibration damping device according to the present inventions even though the tuning frequency of the damper plate 66 diverges to some extent from the natural frequency of the base 62 to be damped, since the natural frequency of the damper plate 66 varies with change in the contact faces of the damper plate 66 and the base 62 due to elastic deformation of the damper plate 66, 80 that resonance behavior is exhibited over a substantially wide frequency band, and it is thought that the desired vibration damping action is consistently attained thereby.

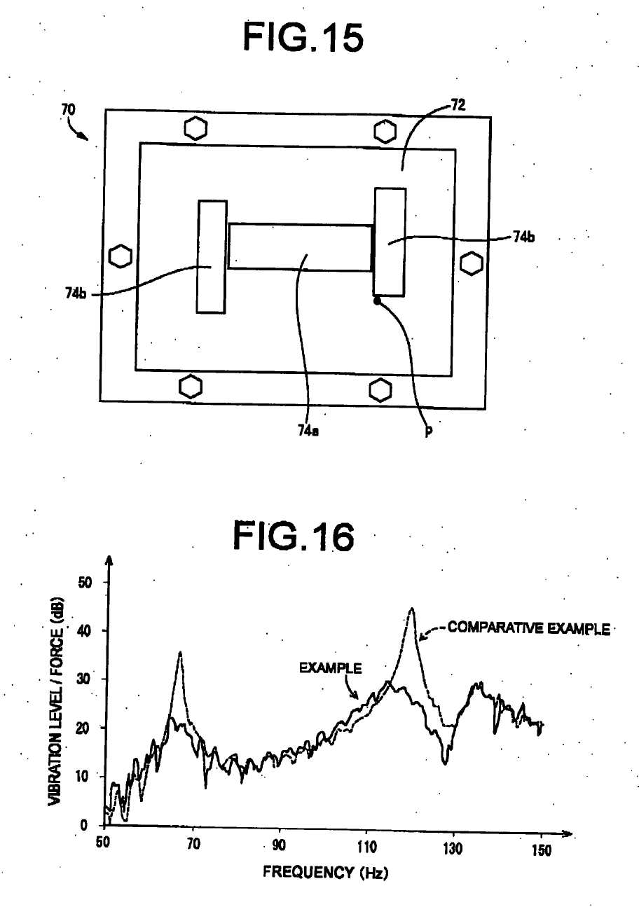

Next, FIG. 15 depicts a testing apparatus 70 for demonstrating another vibration damping action of the invention. The testing apparatus 70 comprises a base 72 having a thin, rectangular flat plate shape as the vibrating member. The peripheral portion of the bass 72 was affixed to a stand. The base 72 was subjected at a prescribed location: P to impact excitation by an impulse hammer, and the primary and secondary vibration modes of the base 72 were examined by mode analysis such as FEM, as well as measuring the primary natural frequency: F₁ and secondary natural frequency: F₂ of the base 72.

A damper plate 74a serving as the elastic plate member was superposed at a location representing an antinode of the primary vibration mode of the base 72, while damper plates 74b, 74b serving as elastic plate members were superposed at locations representing antinodes of the secondary vibration mode of the base 72. Here, the natural frequency of the damper plate 74a has been tuned to the primary natural frequency; F₁ of the base 72, while the natural frequency of the damper plates 74b has been tuned to the secondary natural frequency: F₂ of the base 72.

With the damper plates 74a, 74b, 74b superposed against antinodes of the base 72, excitation force was applied to the proscribed location: P of the base 72 with the impulse hammer, and the resultant vibration level (dB) was measured with a laser vibration gauge of known type. The results are shown as the Example in FIG. 16. Also shown in FIG. 16 as a Comparative Examples are results for vibration level of the base 72 in the absence of the damper plates 74a, 74b, 74b.

It will be apparent from the results in FIG. 16 that vibration damping action is effectively exhibited in a simple construction, simply by superposing the damper plates 74 tuned to the natural frequency or each of a number of multiple-order vibration modes of the base 72, at the antinodes of each mode. Additionally, despite multiple damper plates 74 being provided, since the damper plates 74 have low mass, it is thought possible to attain lighter weight as compared to dynamic dampers or vibration damping structures of conventional design while achieving excellent vibration damping action.

What is claimed is:

1. A vibration damping device comprising:
at least one elastic plate member adapted to be superposed against a surface of a vibrating member to be damped, and having a natural frequency tuned to a frequency band to be damped in the vibrating member; and
a positioning member for positioning the elastic plate member with respect to the surface of the vibrating member.

2. A vibration damping device according to claim 1, wherein a primary natural frequency of the elastic plate member is tuned to the frequency band of vibration to be damped in the vibrating member.

3. A vibration damping device according to claim 1, wherein a natural frequency: f in the elastic plate member is tuned will respect to a frequency: F of the vibration to be damped in the vibrating member, such that 0.8≦f/F≦2.0.

4. A vibration damping device according to claim 1, wherein the elastic plate member and the vibrating member are brought into abutting contact at respective contact faces, and a rubber elastic layer is provided to at least one of the contact faces of the vibrating member and the elastic plate member.

5. A vibration damping device according to claim 1, wherein the positioning member positions an outside peripheral edge of the elastic plate member with respect to the vibrating member.

6. A vibration damping device according to claim 1, wherein wherein the positioning member includes a positioning hole formed onto the elastic plate member, and positions an inside peripheral edge of the positioning hole with respect to the vibrating member.

7. A vibration damping device according to claim 1, wherein a plurality of elastic plate members are superposed at different locations on the surface of the vibrating member.

8. A vibration damping device according to claim 1, wherein the elastic plate member is formed of metal material or resin material.

9. A vibration damping device according to claim 1, wherein the elastic plate member is superposed against the vibrating member at a first side surface having a surface configuration corresponding to the surface of the vibrating member, and the first side surface undergoes elastic deformation upon input of vibration so that the elastic plate member is brought into abutting contact against the vibrating member at a part of the first side surface.
